(19) United States
(12) Patent Application Publication
(10) Pub. No.: US 2026/0358687 A1
(43) Pub. Date: Nov. 12, 2026

(54) PROJECTION DEVICE AND ADJUSTMENT METHOD THEREOF

(71) Applicant: Coretronic Corporation, Hsin-Chu (TW)

(72) Inventors: Chi-Wen Ke, Hsin-Chu (TW); Hung-Wei Lin, Hsin-Chu (TW)

(73) Assignee: Coretronic Corporation, Hsin-Chu (TW)

(21) Appl. No.: 19/645,275

(22) Filed: Apr. 12, 2026

(30) Foreign Application Priority Data
May 6, 2025 (CN) 202510574564.4

(51) Int. Cl. G03B 21/14; H04N 9/31

(52) U.S. Cl. CPC G03B 21/145; H04N 9/3194

(57) ABSTRACT

The present disclosure provides a projection device and an adjustment method. The projection device includes a housing, a first adjustment foot, a second adjustment foot, a projection system, a distance-measuring module, a control unit, and a driving module. The projection system projects an image beam out of the projection device so that the image beam is projected onto a projection plane along a reference axis. The distance-measuring module measures distances between the projection device and multiple reference points on the projection plane to generate distance information. The control unit calculates an angle between the reference axis and the projection plane according to the distance information and determines whether the angle falls within a preset angle range; if not, the control unit controls the driving module to drive the first and second adjustment feet to move, thereby automatically calibrating the respective angle between the projection device and the projection plane.

### CROSS-REFERENCE TO RELATED APPLICATION

This application claims the priority benefit of China application serial no. 202510574564.4, filed on May 6, 2025. The entirety of the above-mentioned patent application is hereby incorporated by reference herein and made a part of this specification.

### BACKGROUND

### Technical Field

The present disclosure relates to a projection device and an adjustment method thereof, for adjusting an angle of the projection device.

### Related Art

When the projection device generates skew or deformation of a projected image because of uneven placement or the projection plane not being perpendicular with a projection direction of the projection device, a user needs to manually adjust, for example, by adjusting an amount of extension and retraction of an adjustment component at a bottom of the projection device, to change a pitch angle and a horizontal tilt angle of the projection device. However, a manual adjustment process mostly relies on a user's subjective determination of whether a target state has been reached, and the user often needs to repeatedly observe and then manually adjust multiple times, and an operation process is complicated and inconvenient and is prone to inaccuracy.

In addition, some projection devices have a built-in Auto Keystone function, which may adjust the image beam through image processing technology, to make the projected image appear rectangular. However, this type of automatic correction by adjusting the image beam may cause the projected image size to be reduced, or cause the image quality to decrease because of image deformation processing. Therefore, existing technology still faces a technical bottleneck between providing convenience and maintaining image quality, and is in urgent need of improvement.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

To solve the above-mentioned problems, the disclosure provides a projection device and an adjustment method for the projection device. Other objects and advantages of the disclosure may be further understood from the technical features disclosed in the disclosure.

To achieve one, some, or all of the aforementioned objects or other objects, the disclosure provides a projection device, including a housing, a first adjustment foot, a second adjustment foot, a projection system, a distance-measuring module, a control unit, and a driving module. The housing has a bottom wall. The projection system is at least partially disposed in the housing and is configured to provide an image beam. The projection system includes a projection lens, for projecting the image beam out of the projection device, such that the image beam is projected along a reference axis to a projection plane. The first adjustment foot is movably disposed through the bottom wall, and the first adjustment foot has a first free end located outside the housing. The second adjustment foot is movably disposed through the bottom wall, and the second adjustment foot has a second free end located outside the housing. Orthographic projections of the first adjustment foot and the second adjustment foot on the bottom wall are respectively located on opposite sides of an orthographic projection of the projection lens on the bottom wall. The driving module is disposed in the housing and connected to the first adjustment foot and the second adjustment foot, for driving the first adjustment foot and/or the second adjustment foot to move, to adjust the distance between the first free end and the bottom wall and/or the distance between the second free end and the bottom wall. The distance-measuring module is disposed on the housing, for measuring distances between the projection device and multiple reference points on the projection plane to generate a plurality of distance information. The control unit is disposed in the housing, electrically connected to the distance-measuring module and the driving module, for receiving the plurality of distance information from the distance-measuring module, calculating, according to the plurality of distance information, a first angle between the reference axis and the projection plane, and determining whether the first angle is in a first preset angle range. In response to the first angle not being in the first preset angle range, the control unit controls the driving module to drive the first adjustment foot and the second adjustment foot to move, to adjust the distance between the first free end and the bottom wall and the distance between the second free end and the bottom wall.

The disclosure further provides an adjustment method for a projection device that is executed by a control unit of the projection device. The projection device includes a housing, a first adjustment foot, a second adjustment foot, a projection system, a distance-measuring module, and a driving module. The housing has a bottom wall. The projection system is configured to provide an image beam and includes a projection lens for projecting the image beam out of the projection device, such that the image beam is projected along a reference axis to a projection plane. The first adjustment foot is movably disposed through the bottom wall, and has a first free end located outside the housing. The second adjustment foot is movably disposed through the bottom wall, and has a second free end located outside the housing. Orthographic projections of the first adjustment foot and the second adjustment foot on the bottom wall are respectively located on opposite sides of an orthographic projection of the projection lens on the bottom wall. The driving module is connected to the first adjustment foot and the second adjustment foot, for driving the first adjustment foot or the second adjustment foot to move, to adjust the distance between the first free end and the bottom wall and/or the distance between the second free end and the bottom wall. The distance-measuring module measures distances between the projection device and multiple reference points on the projection plane to generate a plurality of distance information. The adjustment method includes: receiving the plurality of distance information from the distance-measuring module; calculating, according to the plurality of distance information, a first angle between the reference axis and the projection plane; determining whether the first angle is in a first preset angle range; and in response to the first angle not being in the first preset angle range, controlling the driving module to drive the first adjustment foot and the second adjustment foot to move, to adjust the distance between the first free end and bottom wall and the distance between the second free end and the bottom wall.

In the aforementioned projection device and the adjustment method for the projection device, the angle of the projection device relative to the projection plane may be automatically measured by the distance-measuring module, thereby performing an adjustment of the projection device in a vertical direction (pitch angle) relative to the projection plane, such that a projection direction of the image beam of the projection device is more perpendicular to the projection plane. In addition, because the projection image is corrected by adjusting an angle of an entire housing of the projection device, rather than by adjusting content of the image beam to correct the projection image, disadvantages of conventional projection device built-in keystone correction technology, such as image quality degradation and reduction in projection image size, may thus be avoided.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A is a component block diagram of a projection device of an embodiment of the invention.

FIG. 1B is a component block diagram of a projection device of another embodiment of the invention.

FIG. 2 is a component block diagram of the projection system of FIG. 1A and FIG. 1B of the invention.

FIG. 3 is a schematic bottom plan view of the projection device of FIG. 1A and FIG. 1B of the invention with the projection plane.

FIG. 4 is a schematic perspective view of the projection device of FIG. 1A and FIG. 1B of the invention.

FIG. 5 is a schematic side plan view of the projection device of FIG. 1A and FIG. 1B of the invention with the projection plane.

FIG. 6 is a schematic front plan view of the projection device of FIG. 1A and FIG. 1B of the invention.

FIG. 7 is a flowchart of an adjusting method of the projection device of FIG. 1A of the invention.

FIG. 8 is a flowchart of an adjusting method of the projection device of FIG. 1B of the invention.

### DESCRIPTION OF THE EMBODIMENTS

The aforesaid and other technical contents, features, and efficacies of the invention may be clearly presented in the following detailed description of a preferred embodiment thereof, with reference to the accompanying drawings. The directional terms, such as up, down, left, right, front, or rear, etc., mentioned in the following embodiments are merely for referring to the directions of the accompanying drawings. Therefore, the directional terms used are with an illustrative purpose and not with a limiting purpose for the invention.

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

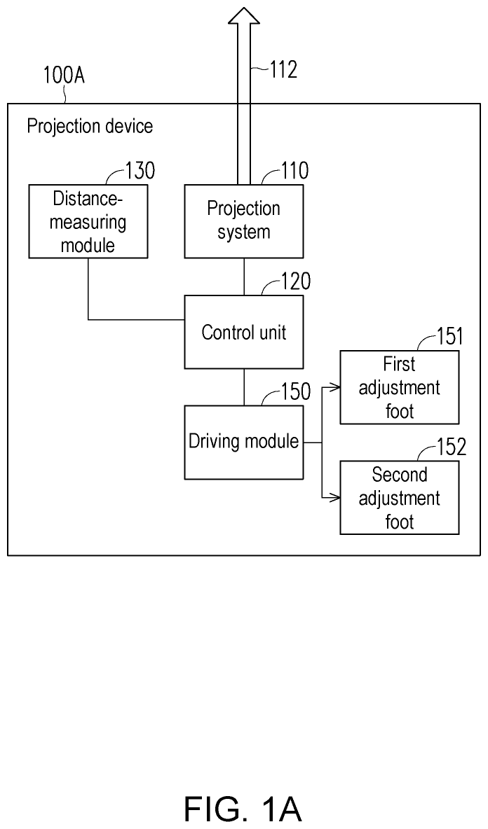

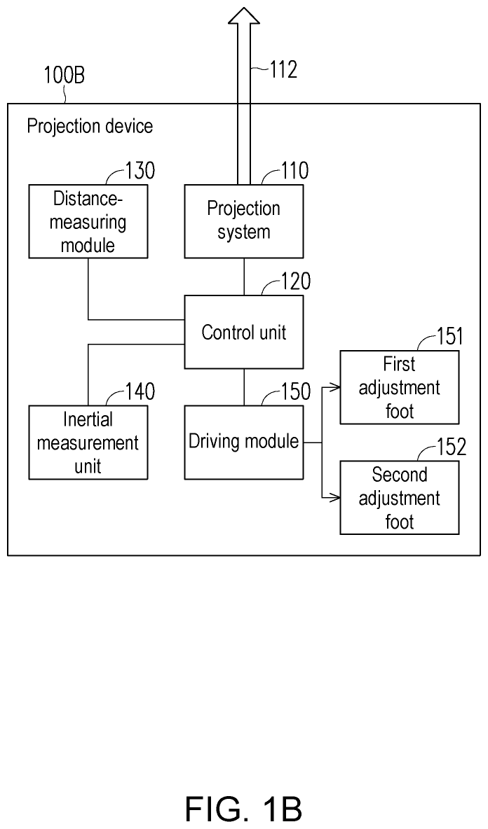

Refer to FIG. 1A, a projection device 100A includes a housing 310, a projection system 110, a control unit 120, a distance-measuring module 130, a driving module 150, a first adjustment foot 151, and a second adjustment foot 152.

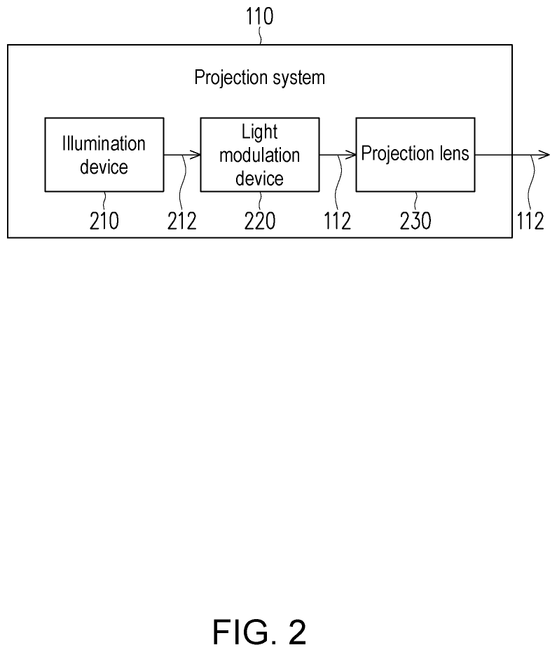

Refer to FIG. 2, wherein the projection system 110 includes an illumination device 210, a light modulation device 220, and a projection lens 230, and is for providing an image beam 112. The illumination device 210 mainly includes a light source module for providing a light source beam and a light combining module for forming the light source beam into an illumination beam. The light source module, for example, includes at least one light-emitting diode or laser diode or a combination thereof. A light valve in the light modulation device 220 may include a reflective spatial light modulator (SLM) or a transmissive spatial light modulator. The reflective spatial light modulator may be, for example, a reflective Liquid Crystal on Silicon (LCOS) panel or a Digital Micro-mirror Device (DMD). The transmissive spatial light modulator may be, for example, a Transparent Liquid Crystal Panel, an Electro-Optical Modulator, a Magneto-Optic modulator, an Acousto-Optic Modulator (AOM), or other transmissive liquid crystal panels. The light modulation device 220 modulates the illumination beam according to a control signal to generate the image beam 112, and provides the image beam 112 to the projection lens 230. The projection lens 230, for example, includes a combination of one or more optical lenses having diopter. The optical lenses, for example, include biconcave lenses, biconvex lenses, concavo-convex lenses, convexo-concave lenses, plano-convex lenses, and plano-concave lenses, or various combinations of such non-planar lenses. The invention does not limit the type and kind of the projection lens 230. Please refer to FIG. 1A and FIG. 2, after the projection lens 230 receives the image beam 112 from the light modulation device 220, it projects the image beam 112 out of the projection device 100A.

Refer to FIG. 1A, the control unit 120 is electrically connected to the projection system 110, the distance-measuring module 130, and the driving module 150. The control unit 120 includes at least one of a central processing unit, a graphics processing unit, a microprocessor, a microcontroller, an image processing chip, Application Specific Integrated Circuits (ASIC), and a Programmable Logic Device (PLD), or a combination thereof.

The distance-measuring module 130 measures the distance between the projection device 100A and surrounding objects outside the projection device 100A. The distance-measuring module 130, for example, includes at least one of a Time of Flight (ToF) sensor module, a dual camera module, a structured light sensor module, an ultrasonic sensor module, and the like.

The driving module 150 is connected to the first adjustment foot 151 and the second adjustment foot 152, and drives the first adjustment foot 151 and/or the second adjustment foot 152 to move. In other words, the driving module 150 may have two driving components (not shown) for respectively driving the two adjustment feet to move, or may simultaneously drive the two adjustment feet to move. The driving module 150 may include a motor, but the disclosure is not limited thereto.

Refer to FIG. 1A, FIG. 2 to FIG. 4, the projection device 100A has a reference coordinate system, including mutually perpendicular X, Y, and Z axes. The control unit 120 and the driving module 150 of the projection device 100A are disposed in the housing 310, and the distance-measuring module 130 is disposed on the housing 310 or in the housing 310, and a sensing beam emitted from the distance-measuring module 130 can pass through an opening or a transmissive portion of the housing 310. The projection system 110 is at least partially disposed in the housing 310, wherein the illumination device 210 and the light modulation device 220 are disposed in the housing 310, and a part of the projection lens 230 may be disposed outside the housing 310 and another part is disposed in the housing 310.

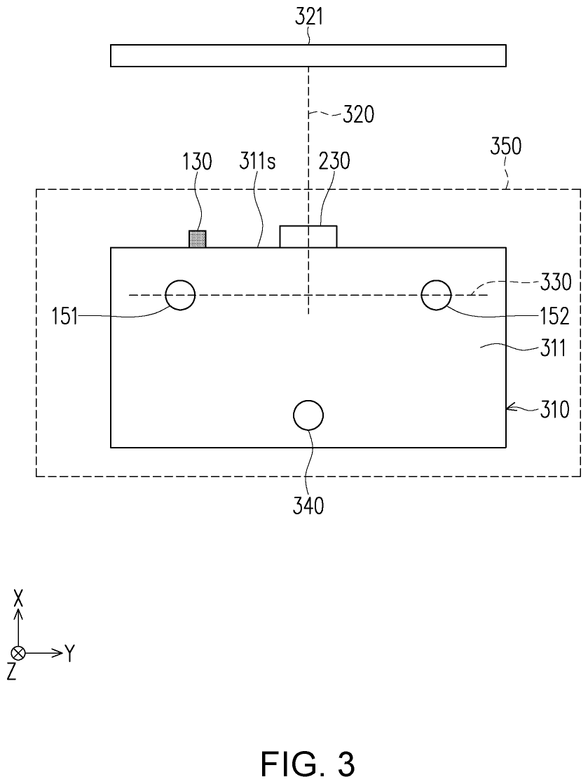

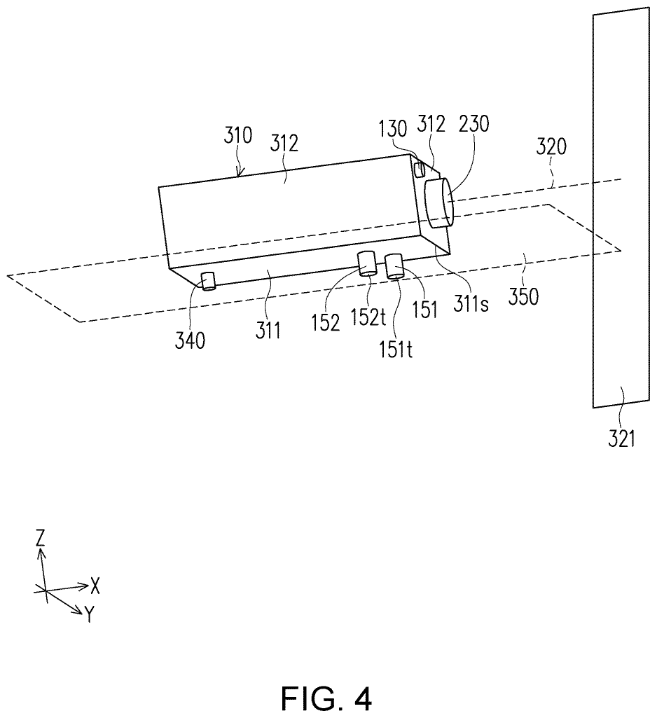

Refer to FIG. 3 and FIG. 4. Specifically, the housing 310 has a bottom wall 311 and a plurality of sidewalls 312. The bottom wall 311 is disposed along a reference plane 350, and the reference plane 350 is parallel to the X-axis and the Y-axis of the reference coordinate system. The plurality of sidewalls 312 are disposed around a periphery of the bottom wall 311. In this embodiment, the number of the sidewalls 312 is four, respectively surrounding four peripheries of the bottom wall 311, to define an accommodating space (not labeled) of the housing 310. The control unit 120, the driving module 150, and at least a part of the projection system 110 are disposed in the accommodating space. The projection lens 230, for example, partially passes through one of the plurality of sidewalls 312, for projecting an image beam 112 along a reference axis 320 towards a projection plane 321 outside the projection device 100A, to form a projected image (not shown) on the projection plane 321. The reference axis 320 is parallel to the X-axis of the reference coordinate system.

The bottom wall 311 of the housing 310, for example, has two through holes, respectively for disposing the first adjustment foot 151 and the second adjustment foot 152, such that a part of each of the first adjustment foot 151 and the second adjustment foot 152 is located in the housing 310, and another part is located outside the housing 310. The driving module 150, for example, is connected to the part of each of the first adjustment foot 151 and the second adjustment foot 152 located in the housing 310, such that the first adjustment foot 151 and the second adjustment foot 152 may movably pass through the bottom wall 311 through the through holes. In some embodiments, the projection device 100A further has a fixed foot 340. This fixed foot 340 is disposed on the bottom wall 311, but may not move relative to the bottom wall 311. Orthographic projections of the first adjustment foot 151 and the second adjustment foot 152 on the bottom wall 311 (or the reference plane 350) are respectively located on opposite two sides of an orthographic projection of the projection lens 230 on the bottom wall 311 (or the reference plane 350), and are on two sides of the reference axis 320. In an embodiment, the orthographic projections of the first adjustment foot 151 and the second adjustment foot 152 on the bottom wall 311 (or the reference plane 350) are symmetrically located on opposite two sides of an orthographic projection of the projection lens 230 on the bottom wall 311 (or the reference plane 350).

A first connecting line 330 is formed between a disposition position of the first adjustment foot 151 on the bottom wall 311 and a disposition position of the second adjustment foot 152 on the bottom wall 311. The first connecting line 330 is parallel with a side edge 311s of the bottom wall 311, and the side edge 311s of the bottom wall 311 corresponds with the sidewall 312 where the projection lens 230 is located. The side edge 311s, for example, is parallel to the Y-axis.

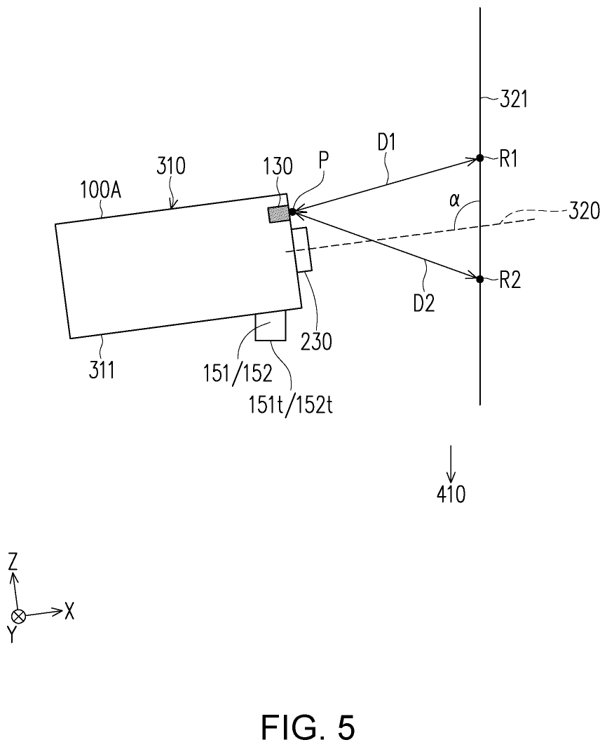

Refer to FIG. 4 and FIG. 5, the first adjustment foot 151 has a first free end 151t located outside the housing 310, and the second adjustment foot 152 has a second free end 152t located outside the housing 310. The first and second free ends 151t, 152t contact a support surface (e.g. a ground surface or a desktop surface) located outside the projection device 100A, such that a posture of the projection device 100A is determined according to distances of the first and second free ends 151t, 152t from the bottom wall 311 (in other words, the distance between the bottom wall 311 and the support surface). The driving module 150 can drive the first adjustment foot 151 and the second adjustment foot 152 to move relative to the housing 310, thereby adjusting the distance between the first and second free ends 151t, 152t and the bottom wall 311. For example, when the driving module 150 moves the first adjustment foot 151 and the second adjustment foot 152 towards outside the housing 310, the distances of the first and second free ends 151t, 152t from the bottom wall 311 are increased, such that the projection device 100A is lifted relative to the support surface; conversely, when the driving module 150 moves the first adjustment foot 151 and the second adjustment foot 152 towards inside the housing 310, the distances of the first and second free ends 151t, 152t from the bottom wall 311 are decreased, such that the projection device 100A approaches the support surface. As the distance between the first and second free ends 151t, 152t and the bottom wall 311 changes, an angle between the reference axis 320 and the projection plane 321 will also be changed. In the invention, the control unit 120 executes an adjustment method of the projection device 100A, such that the reference axis 320 is perpendicular to, or approximately perpendicular to, the projection plane 321, and/or the bottom wall 311 is horizontal or approximately horizontal with respect to the horizontal plane.

Refer to FIG. 5, first, the distance-measuring module 130 measures distances between the projection device 100A and multiple reference points on the projection plane 321 to generate distance information. Taking the distance-measuring module 130 as a ToF sensor module for example, the distance-measuring module 130 sequentially or simultaneously sends multiple distance-measuring beams towards the projection plane 321. These distance-measuring beams are projected on the projection plane 321 to form multiple reference points. According to a time taken for the distance-measuring beams to be reflected by the projection plane 321 back to a receiver (not shown) of the distance-measuring module 130, the distance-measuring module 130 calculates multiple distances between these reference points on the projection plane 321 and the projection device 100A. In this embodiment, preferably, the distance-measuring beams of the distance-measuring module 130 form at least a reference point R1 and a reference point R2 on the projection plane 321. The distance-measuring module 130 has a measurement reference point P. A plane formed by the reference point R1, the reference point R2, and the measurement reference point P is parallel to a vertical direction 410 (or a gravitational direction). In this embodiment, the reference axis 320, for example, has an intersection point with the projection plane 321, the reference point R1 is located above the intersection point of the reference axis 320 and the projection plane 321, and the reference point R2 is located below the intersection point of the reference axis 320 and the projection plane 321, but the invention is not limited thereto. In other embodiments, the reference points R1, R2 may both be above or below the reference axis 320, as long as the positions of the reference points R1, R2 in the vertical direction 410 are different. The distance-measuring module 130 will measure a distance D1 between the projection device 100A and the reference point R1, and a distance D2 between the projection device 100A and the reference point R2. Specifically, the distance-measuring module 130 measures the distances D1, D2 between the measurement reference point P and the reference points R1, R2. The distance information include the distance D1 corresponding to the reference point R1 and the distance D2 corresponding to the reference point R2. The measurement reference point P is, for example, a position where the distance-measuring module 130 is disposed on the housing 310.

Next, the control unit 120 receives the distance information from the distance-measuring module 130, and calculates a first angle α between the reference axis 320 and the projection plane 321 according to the distance information. When the first angle α increases, the distance D1 will increase and the distance D2 will decrease; conversely, when the first angle α decreases, the distance D1 will decrease and the distance D2 will increase. Since an angle at which the distance-measuring module 130 sends these distance-measuring beams is fixed and known, the control unit 120 may obtain the first angle α by inputting these angles and the distances D1, D2 into an equation preset according to trigonometric functions. In addition, in some embodiments, a corresponding lookup table of a ratio of the distances D1 and D2 (D1/D2 or D2/D1) to the first angle α may also be preset according to the aforementioned calculation principle, and the corresponding lookup table is stored in the control unit 120 or in a storage unit connected with the control unit 120. After the distance-measuring module 130 performs measurement to generate the distance information, the control unit 120 calculates the ratio, and obtains the first angle α based on the corresponding lookup table and the ratio. The aforementioned equation and corresponding lookup table may be determined by deduction and/or experiment.

Then, the control unit 120 determines whether the first angle α is in a first preset angle range. If the first angle α is in the first preset angle range, then it is not necessary to adjust the first adjustment foot 151 and the second adjustment foot 152. If the first angle α is not in the first preset angle range, then the control unit 120 controls the driving module 150 to drive the first adjustment foot 151 and the second adjustment foot 152 to move, to adjust the distances of the first free end 151t and the second free end 152t from the bottom wall 311. In some embodiments, a lower limit value of the first preset angle range is 90−x degrees, and an upper limit value of the first preset angle range is 90+x degrees, where x is greater than or equal to 0 and less than or equal to 5. x is an error tolerance value, and therefore, a value of x may be set according to an accuracy requirement of the adjustment method. In other words, in this embodiment, when the first angle α is in the first preset angle range, it represents that the first angle α approaches 90 degrees, that is, the reference axis 320 is approximately perpendicular to the projection plane 321.

Specifically, the first preset angle range has the upper limit value and the lower limit value. In response to the control unit 120 determining that the first angle α is less than the lower limit value of the first preset angle range, the control unit 120 controls the driving module 150 to drive the first adjustment foot 151 and the second adjustment foot 152 to move in a direction away from the bottom wall 311 by a preset distance, such that the distances of the first free end 151t and the second free end 152t from the bottom wall 311 are increased, thereby increasing the first angle α. On the other hand, in response to the control unit 120 determining that the first angle α is greater than the upper limit value of the first preset angle range, the control unit 120 controls the driving module 150 to drive the first adjustment foot 151 and the second adjustment foot 152 to move in a direction towards the bottom wall 311 by the preset distance, such that the distances of the first free end 151t and the second free end 152t from the bottom wall 311 are decreased, thereby decreasing the first angle α. In this embodiment, each time the control unit 120 controls the driving module 150 to drive the first adjustment foot 151 and the second adjustment foot 152 to move the preset distance. Then, the distance-measuring module 130 again receives the distances D1, D2, calculates the first angle α, and determines whether the first angle α is in the first preset angle range. The foregoing steps are repeatedly executed until it is determined that the first angle α is in the first preset angle range. In other embodiments, the control unit 120 may also directly calculate a target movement amount, and control the driving module 150 to drive the first adjustment foot 151 and the second adjustment foot 152 to move by the target movement amount.

The first adjustment foot 151 and the second adjustment foot 152 have a movement amount limit due to, for example, lengths of the adjustment feet 151, 152 or an actuation limit of the drive component 150. Therefore, when the first adjustment foot 151 and the second adjustment foot 152 move to a movement amount limit position and the first angle α is not yet in the first preset angle range, the control unit 120 generates a first warning message, and controls the projection device 100A to output the first warning message. For example, the control unit 120 may control the projection system 110 to display a pattern or text by an on screen display (OSD) interface, as the first warning message. Alternatively, the control unit 120 may output the first warning message by a way of sound through a speaker built in the projection device 100A, the invention is not limited thereto. The first warning message is to prompt a user that a vertical adjustment part in an adjustment method of the projection device fails to be executed, and an adjustment of the environment should be manually performed.

Specifically, in responding to the control unit 120 determining that the first angle α is less than the lower limit value of the first preset angle range, and the distance of the first free end 151t of the first adjustment foot 151 or the second free end 152t of the second adjustment foot 152 from the bottom wall 311 reaches a maximum distance, the control unit 120 generates the first warning message. On the other hand, in responding to the control unit 120 determining that the first angle α is greater than the upper limit value of the first preset angle range, and the distance of the first free end 151t or the second free end 152t from the bottom wall 311 reaches a minimum distance, the control unit 120 also generates the first warning message.

FIG. 1B is a component block diagram of a projection device of another embodiment of the invention. A projection device 100B of this embodiment is similar to the projection device 100A of FIG. 1A, and the control unit 120 of the projection device 100B is similar to the projection device 100A in that the control unit 120 executes an adjustment method of the projection device 100A, such that the reference axis 320 and the projection plane 321 are vertical or approximately vertical, and/or the bottom wall 311 is horizontal or approximately horizontal with a relative horizontal plane. However, the main difference between the two is that: in this embodiment, the projection device 100B further includes an inertial measurement unit 140, the inertial measurement unit 140 is disposed in the housing 310 and coupled to the control unit 120, to measure a posture of the projection device 100B to generate device posture information. The inertial measurement unit 140 may include an accelerometer, a gyroscope, a magnetometer, etc. The aforementioned device posture information may at least include acceleration and angular acceleration values of X, Y, and Z axes.

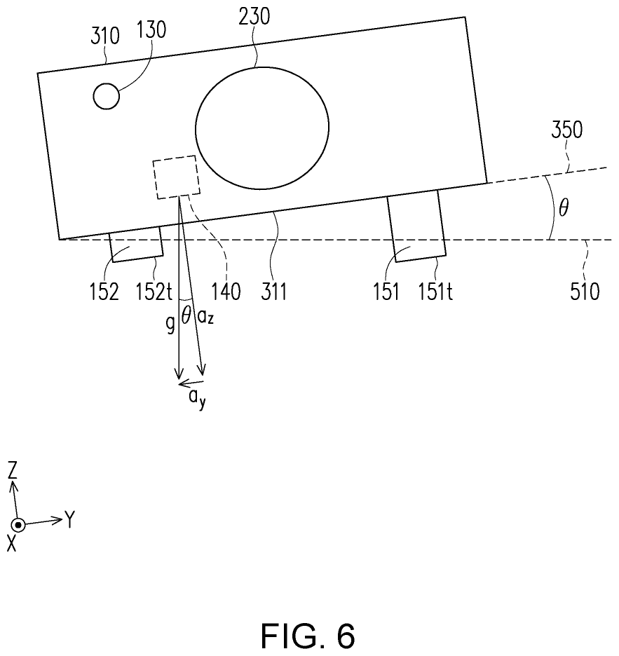

Refer to FIG. 1B, FIG. 4 and FIG. 6, the device posture information generated by the inertial measurement unit 140 includes values respectively corresponding to X, Y, and Z axes of the reference coordinate system. The control unit 120 receives the device posture information from the inertial measurement unit 140, and according to the device posture information calculates a second angle θ between the reference plane 350 of the projection device 100B and the horizontal plane 510. As the reference plane 350 is not parallel with the horizontal plane 510, the second angle θ is greater than 0. Specifically, according to the horizontal plane 510 being vertical with the gravitational acceleration g, and the Z-axis value a_{z} in the device posture information is the gravitational acceleration g multiplied by cos θ, and the Y-axis value a_{y} is the gravitational acceleration g multiplied by sin θ. The second angle θ may be calculated through the following equation 1 and equation 2.

$$\frac{{a}_{y}}{{a}_{z}} = \frac{sin θ}{cos θ} = tan θ \qquad [ Equation 1 ]$$

$$θ = arctan \frac{{a}_{y}}{{a}_{z}} \qquad [ Equation 2 ]$$

The unit of the second angle θ calculated in the equation 2 is radian, and degrees may be obtained by multiplying this radian by 180 and then dividing by pi.

Next, the control unit 120 determines whether the second angle θ is in a second preset angle range. In response to the second angle θ not being in the second preset angle range, the control unit 120 controls the driving module 150 to drive at least one of the first adjustment foot 151 and the second adjustment foot 152 to move, to adjust the distance of at least one of the first free end 151t and the second free end 152t from the bottom wall 311. Therefore, the second angle θ eventually approaches 0 degrees, and the bottom wall 311 (the reference plane 350) of the housing 310 approaches parallel with the horizontal plane 510. Generally speaking, as the second angle θ is greater than 0 degrees, adjustment may be performed by shortening the first adjustment foot 151 or extending the second adjustment foot 152; as the second angle θ is less than 0 degrees, adjustment may be performed by extending the first adjustment foot 151 or shortening the second adjustment foot 152. Specifically, an upper limit value of the second preset angle range is +y degrees, and a lower limit value is −y degrees, where y is greater than or equal to 0 and for example is less than or equal to 5. y is an error tolerance value, and therefore the value of y may be set according to an accuracy requirement of the adjustment method. In other words, in this embodiment, as the second angle θ is in the second preset angle range, it represents that the second angle θ approaches 0 degrees, and the bottom wall 311 of the housing 310 approaches parallel with the horizontal plane 510.

Specifically, in response to the control unit 120 determining that the second angle θ is greater than the upper limit value of the second preset angle range, the control unit 120 controls the driving module 150 to drive the first adjustment foot 151 to move towards the bottom wall 311 by a preset distance, such that the distance between the first free end 151t and the bottom wall 311 is decreased, or/and controls the driving module 150 to drive the second adjustment foot 152 to move away from the bottom wall 311 by the preset distance, such that the distance between the second free end 152t and the bottom wall 311 is increased. On the other hand, in response to the control unit 120 determining that the second angle θ is less than the lower limit value of the second preset angle range, the control unit 120 controls the driving module 150 to drive the first adjustment foot 151 to move away from the bottom wall 311 by the preset distance, such that the distance between the first free end 151t and the bottom wall 311 is increased, or/and controls the driving module 150 to drive the second adjustment foot 152 to move towards the bottom wall 311 by the preset distance, such that the distance between the second free end 152t and the bottom wall 311 is decreased.

In some embodiments, the control unit 120 controls the driving module 130 to drive the shorter one of the first adjustment foot 151 and the second adjustment foot 152 (of which the distance with the bottom wall 311 is shorter) to adjust by moving outwards, to adjust the angle of the bottom wall 311 with the horizontal plane 510. If the adjustment foot has reached an extension limit (the distance with the bottom wall 311 reaches a maximum distance), the control unit 120 then controls the driving module 130 to drive the other adjustment foot to move inwards.

Specifically, in response to the control unit 120 determining that the second angle θ is less than the lower limit value of the second preset angle range, the control unit 120 first controls the driving module 150 to drive the first adjustment foot 151 to move away from the bottom wall 311 by the preset distance, such that the distance of the first free end 151t from the bottom wall 311 is increased. When the distance of the first free end 151t from the bottom wall 311 already reaches a maximum distance, then the control unit 120 controls the driving module 130 to drive the second adjustment foot 152 to move towards the bottom wall 311 by the preset distance, such that the distance between the second free end 152t and the bottom wall 311 is decreased, thereby increasing the second angle θ. In addition, in response to the control unit 120 determining that the second angle θ is greater than the upper limit value of the second preset angle range, the control unit 120 first controls the driving module 150 to drive the second adjustment foot 152 to move away from the bottom wall 311 by the preset distance, such that the distance of the second free end 152t from the bottom wall 311 is increased. When the distance between the second free end 152t and the bottom wall 311 reaches a maximum distance, then the control unit 120 controls the driving module 130 to drive the first adjustment foot 151 to move towards the bottom wall 311 by the preset distance, such that the distance between the first free end 151t of the first adjustment foot 151 and the bottom wall 311 is decreased, thereby reducing the second angle θ.

However, if both the first adjustment foot 151 and the second adjustment foot 152 have reached their travel limits, and the second angle θ is still not in the second angle range, then the control unit 120 generates a second warning message, and controls the projection device 100B to output the second warning message. The output method of the second warning message is, for example, identical with that of the first warning message, and details are not repeated herein. The second warning message is configured for prompting a user that the horizontal adjustment part in the adjustment method of the projection device has failed to execute, and adjustment of the environment should be manually performed.

For example, in response to the control unit 120 determining that the second angle θ is less than the lower limit value of the second preset angle range, the distance between the second free end 152t of the second adjustment foot 152 and the bottom wall 311 reaches the minimum distance, and the distance between the first free end 151t and the bottom wall 311 reaches the maximum distance, then the control unit 120 generates the second warning message. In addition, in response to the control unit 120 determining that the second angle θ is greater than the upper limit value of the second preset angle range, the distance between the first free end 151t of the first adjustment foot 151 and the bottom wall 311 reaches the minimum distance, and the distance between the second free end 152t of the second adjustment foot 152 and the bottom wall 311 reaches the maximum distance, the control unit 120 also generates the second warning message.

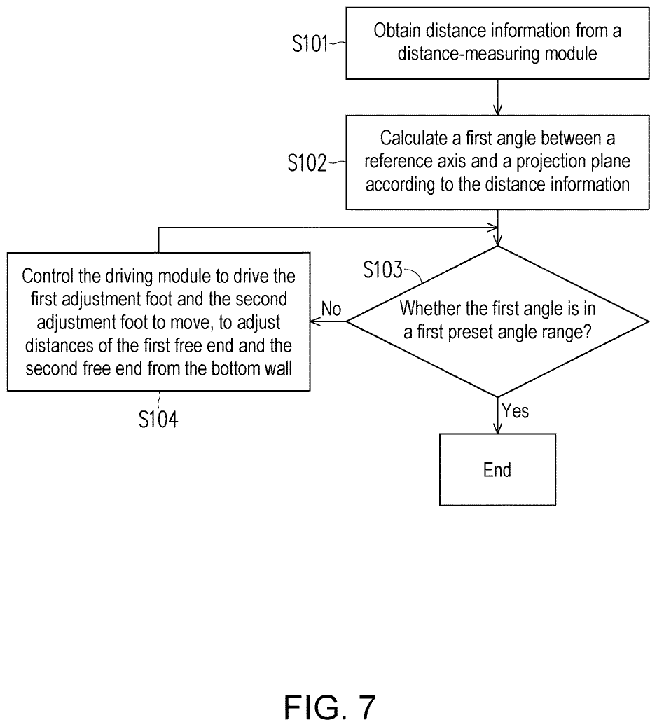

Refer to FIG. 7, an adjustment method for a projection device of the invention includes steps S101-S104, executed by the control unit 130 of the projection device 100A. In step S101, distance information is obtained from a distance-measuring module. In step S102, according to the distance information, a first angle between a reference axis and a projection plane is calculated. In step S103, it is determined whether the first angle is in a first preset angle range. If a result of step S103 is “No”, in step S104, the control unit 130 controls the driving module to drive the first adjustment foot and the second adjustment foot to move, to adjust distances of the first free end of the first adjustment foot and the second free end of the second adjustment foot from the bottom wall. If the result of step S103 is “Yes”, then the process ends.

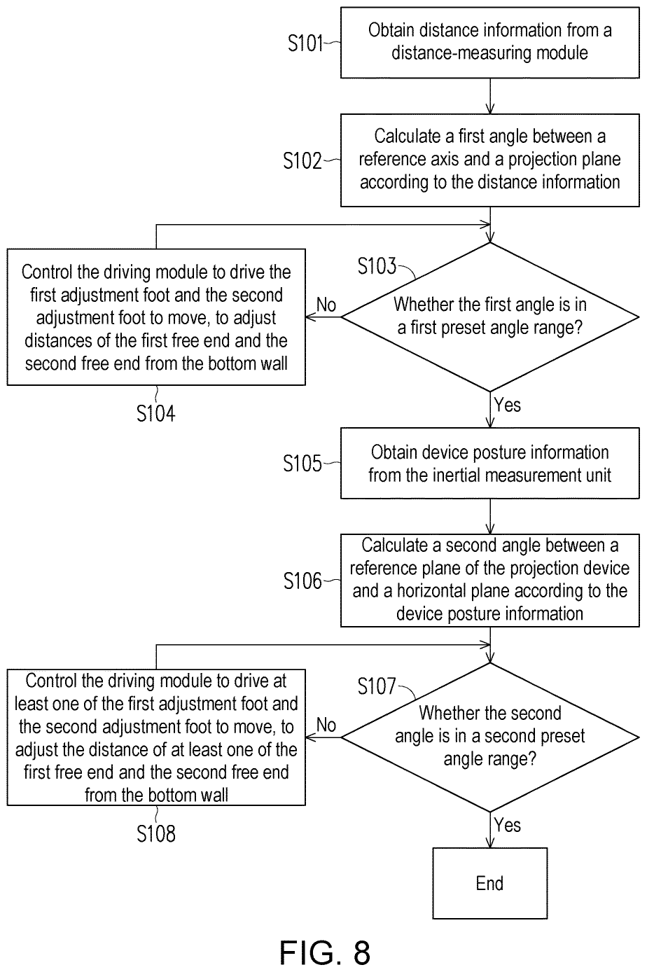

Refer to FIG. 8, in another embodiment, except for the aforementioned steps S101-S104, the adjustment method for the projection device of the invention further includes steps S105-S108. When step S103 is determined as “Yes”, step S105 is entered. In step S105, device posture information is obtained from the inertial measurement unit. In step S106, according to the device posture information, a second angle between a reference plane of the projection device and a horizontal plane is calculated. In step S107, it is determined whether the second angle is in a second preset angle range. If a result of step S107 is “No”, in step S108, the driving module is controlled to drive at least one of the first adjustment foot and the second adjustment foot to move, to adjust the distance of at least one of the first free end of the first adjustment foot and the second free end of the second adjustment foot from the bottom wall. If the result of step S107 is “Yes”, this process ends. Alternatively, an adjustment completion message is generated and output. It should be noted that, in other embodiments, the order between the steps S101-S104 (i.e. vertical adjustment) and steps S105-S108 (i.e. horizontal adjustment) may be interchanged. In other words, the steps S105-S108 may be executed first, and when a determination result of S107 is “Yes”, the steps S101-S104 are then executed.

An output method of the adjustment completion message may be similar to that of the first warning message and the second warning message, and details thereof are not repeated herein. Regarding detailed implementations of each step S101-S108, please refer to the foregoing description of the operation method and means of the projection device of the invention, and details thereof are also not repeated herein.

The adjustment method for the projection device of the invention may be implemented as multiple program codes or circuits, and the invention is not limited thereto.

In summary, the projection device and the adjustment method for the projection device of embodiments of the invention at least have one of the following advantages: adjustment in a horizontal direction (i.e. roll angle) and a vertical direction (i.e. pitch angle) may be automatically performed, to solve the disadvantages of manual adjustment in the prior art and the projection device performing keystone correction technology by modulating an image beam.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device, comprising a housing, a first adjustment foot, a second adjustment foot, a projection system, a distance-measuring module, a control unit, and a driving module, wherein
the housing comprises a bottom wall;
the projection system is at least partially disposed in the housing and is configured to provide an image beam, the projection system comprises a projection lens to project the image beam out of the projection device, such that the image beam is projected along a reference axis to a projection plane;
the first adjustment foot is movably disposed through the bottom wall, and the first adjustment foot comprises a first free end located outside the housing;
the second adjustment foot is movably disposed through the bottom wall, and the second adjustment foot comprises a second free end located outside the housing; wherein orthographic projections of the first adjustment foot and the second adjustment foot on the bottom wall are respectively located at opposite sides of an orthographic projection of the projection lens on the bottom wall;
the driving module is disposed in the housing and is connected to the first adjustment foot and the second adjustment foot and configured to drive the first adjustment foot or/and the second adjustment foot to move, to adjust a distance between the first free end or/and the second free end and the bottom wall;
the distance-measuring module is disposed on the housing or in the housing and configured to measure distances between the projection device and a plurality of reference points on the projection plane to generate distance information;
the control unit is disposed in the housing and electrically connected to the distance-measuring module and the driving module, and configured to receive the distance information from the distance-measuring module, calculate a first angle between the reference axis and the projection plane according to the distance information, and determine whether the first angle is within a first preset angle range; and
wherein in response to the first angle not being within the first preset angle range, the control unit controls the driving module to drive the first adjustment foot and the second adjustment foot to move, to adjust a distance between the first free end and the bottom wall and a distance between the second free end and the bottom wall.

2. The projection device as claimed in claim 1, wherein the plurality of reference points comprise a first reference point and a second reference point, a plane formed by the first reference point, the second reference point, and a measurement reference point of the distance-measuring module is parallel to a vertical direction;
there are a first distance between the first reference point and the projection device, and a second distance between the second reference point and the projection device;
the control unit is configured to calculate a ratio between the first distance and the second distance, and determine the first angle according to the ratio.

3. The projection device as claimed in claim 2, wherein,
in response to the control unit determining that the first angle is less than a lower limit value of the first preset angle range, the control unit controls the driving module to drive the first adjustment foot and the second adjustment foot to move by a preset distance towards a direction away from the bottom wall, such that the distance between the first free end and the bottom wall and the distance between the second free end and the bottom wall are increased;
in response to the control unit determining that the first angle is greater than an upper limit value of the first preset angle range, the control unit controls the driving module to drive the first adjustment foot and the second adjustment foot to move by the preset distance towards a direction approaching the bottom wall, such that the distance between the first free end from the bottom wall and the distance between the second free end and the bottom wall are decreased.

4. The projection device as claimed in claim 3, wherein the lower limit value of the first preset angle range is 90−x degrees, the upper limit value of the first preset angle range is 90+x degrees, wherein x is greater than or equal to 0 and less than or equal to 5.

5. The projection device as claimed in claim 1, wherein,
in response to the control unit determining that the first angle is less than a lower limit value of the first preset angle range, and the distance between the first free end of the first adjustment foot and the bottom wall or the distance between the second free end of the second adjustment foot and the bottom wall reaches a maximum distance, the control unit generates a first warning message; or
in response to the control unit determining that the first angle is greater than an upper limit value of the first preset angle range, and the distance between the first free end of the first adjustment foot and the bottom wall or the distance between the second free end of the second adjustment foot and the bottom wall reaches a minimum distance, the control unit generates the first warning message.

6. The projection device as claimed in claim 5, further comprising:
an inertial measurement unit, disposed in the housing and electrically connected to the control unit, and configured to measure a posture of the projection device to generate a device posture information;
wherein the control unit is further configured to receive the device posture information from the inertial measurement unit, calculate a second angle between a reference plane of the projection device and a horizontal plane according to the device posture information, and determine whether the second angle is in a second preset angle range, the reference plane is parallel to the bottom wall;
wherein in response to the second angle not being in the second preset angle range, the control unit controls the driving module to drive at least one of the first adjustment foot and the second adjustment foot to move, to adjust the distance between the bottom wall and at least one of the first free end and the second free end.

7. The projection device as claimed in claim 6, wherein,
in response to the control unit determining that the second angle is greater than an upper limit value of the second preset angle range, the control unit controls the driving module to drive the first adjustment foot to move by a preset distance towards a direction approaching the bottom wall, such that the distance between the first free end and the bottom wall is decreased, or/and controls the driving module to drive the second adjustment foot to move by the preset distance towards a direction away from the bottom wall, such that the distance between the second free end and the bottom wall is increased;
in response to the control unit determining that the second angle is less than a lower limit value of the second preset angle range, the control unit controls the driving module to drive the first adjustment foot to move by the preset distance towards a direction away from the bottom wall, such that the distance between the first free end and the bottom wall is increased, or/and controls the driving module to drive the second adjustment foot to move by the preset distance towards the direction approaching the bottom wall, such that the distance between the second free end and the bottom wall is decreased.

8. The projection device as claimed in claim 7, wherein the second preset angle range is −y degrees to +y degrees, y is greater than or equal to 0 and less than or equal to 5.

9. The projection device as claimed in claim 7, wherein,
in response to the control unit determining that the second angle is less than the lower limit value of the second preset angle range, and the distance between the first free end of the first adjustment foot and the bottom wall reaches the maximum distance, the control unit controls the driving module to drive the second adjustment foot to move by the preset distance towards the direction approaching the bottom wall, such that the distance between the second free end and the bottom wall is decreased;
in response to the control unit determining that the second angle is less than the lower limit value of the second preset angle range, the distance between the first free end of the first adjustment foot and the bottom wall reaches the maximum distance, and the distance between the second free end of the second adjustment foot and the bottom wall reaches the minimum distance, the control unit generates a second warning message;
in response to the control unit determining that the second angle is greater than the upper limit value of the second preset angle range, and the distance between the second free end of the second adjustment foot and the bottom wall reaches the maximum distance, the control unit controls the driving module to drive the first adjustment foot to move by the preset distance towards the direction approaching the bottom wall, such that the distance between the first free end and the bottom wall is decreased;
in response to the control unit determining that the second angle is greater than the upper limit value of the second preset angle range, the distance between the first free end of the first adjustment foot and the bottom wall reaches the minimum distance, and the distance between the second free end and the bottom wall reaches the maximum distance, the control unit generates the second warning message.

10. The projection device as claimed in claim 1, wherein,
a first connecting line is formed between an installation position of the first adjustment foot on the bottom wall and an installation position of the second adjustment foot on the bottom wall, and the first connecting line is parallel with a side edge of the bottom wall, and the side edge of the bottom wall corresponding to a sidewall where the projection lens is located.

11. The projection device as claimed in claim 6, wherein,
in response to the control unit determining that the first angle is in the first preset angle range and the second angle is in the second preset angle range, the control unit generates an adjustment completion message.

12. An adjusting method for a projection device, executed by a control unit of the projection device, the projection device further comprising a housing, a first adjustment foot, a second adjustment foot, a projection system, a distance-measuring module, and a driving module; the housing has a bottom wall; the projection system is configured to provide an image beam and comprises a projection lens, the projection lens is configured to project the image beam out of the projection device, such that the image beam is projected along a reference axis to a projection plane; the first adjustment foot is movably disposed through the bottom wall, and has a first free end located outside the housing; the second adjustment foot is movably disposed through the bottom wall, and has a second free end located outside the housing; orthographic projections of the first adjustment foot and the second adjustment foot on the bottom wall are respectively located on opposite sides of an orthographic projection of the projection lens on the bottom wall; the driving module is connected to the first adjustment foot and the second adjustment foot, configured to drive the first adjustment foot or the second adjustment foot to move, to adjust a distance between the first free end and bottom wall and/or a distance between the second free end and the bottom wall; the distance-measuring module is configured to measure distances between the projection device and a plurality of reference points on the projection plane to generate a plurality of distance information; the adjusting method for the projection device comprises:
receiving the plurality of distance information from the distance-measuring module;
calculating a first angle between the reference axis and the projection plane according to the plurality of distance information;
determining whether the first angle is in a first preset angle range; and
in response to the first angle not being in the first preset angle range, controlling the driving module to drive the first adjustment foot and the second adjustment foot to move, to adjust the distance between the first free end and the bottom wall and the distance between the second free end and the bottom wall.

13. The adjusting method for the projection device as claimed in claim 12, wherein the plurality of reference points comprise a first reference point and a second reference point, a plane formed by the first reference point, the second reference point, and a measurement reference point of the distance-measuring module is parallel with a vertical direction; there are a first distance between the first reference point and the projection device, and a second distance between the second reference point and the projection device; the adjusting method for the projection device further comprising:
calculating a ratio between the first distance and the second distance, and calculating the first angle according to the ratio.

14. The adjusting method for the projection device as claimed in claim 13, further comprising:
in response to determining that the first angle is less than a lower limit value of the first preset angle range, controlling the driving module to drive the first adjustment foot and the second adjustment foot to move towards a direction away from the bottom wall by a preset distance, such that the distance between the first free end and the bottom wall and the distance between the second free end and the bottom wall are increased;
in response to determining that the first angle is greater than an upper limit value of the first preset angle range, controlling the driving module to drive the first adjustment foot and the second adjustment foot to move towards a direction approaching the bottom wall by the preset distance, such that the distance between the first free end and the bottom wall and the distance between the second free end and the bottom wall are decreased.

15. The adjusting method for the projection device as claimed in claim 14, wherein the lower limit value of the first preset angle range is 90−x degrees, the upper limit value of the first preset angle range is 90+x degrees, wherein x is greater than or equal to 0 and less than or equal to 5.

16. The adjusting method for the projection device as claimed in claim 15, further comprising:
in response to determining that the first angle is less than the lower limit value of the first preset angle range, and the distance between the first free end of the first adjustment foot and the bottom wall or the distance between the second free end of the second adjustment foot and the bottom wall reaches a maximum distance, generating a first warning message; or
in response to determining that the first angle is greater than the upper limit value of the first preset angle range, and the distance between the first free end of the first adjustment foot and the bottom wall or the distance between the second free end of the second adjustment foot and the bottom wall reaches a minimum distance, generating the first warning message.

17. The adjusting method for the projection device as claimed in claim 16, wherein the projection device further comprises an inertial measurement unit configured to measure a posture of the projection device to generate a device posture information; the adjusting method for the projection device further comprising:
receiving the device posture information from the inertial measurement unit;
calculating a second angle between a reference plane of the projection device and a horizontal plane according to the device posture information, the reference plane is parallel to the bottom wall of the projection device;
determining whether the second angle is within a second preset angle range; and
in response to determining that the second angle is not within the second preset angle range, controlling the driving module to drive at least one of the first adjustment foot and the second adjustment foot to move, to adjust the distance between the bottom wall and at least one of the first free end and the second free end.

18. The adjusting method for the projection device as claimed in claim 17, further comprising,
in response to determining that the second angle is greater than an upper limit value of the second preset angle range, controlling the driving module to drive the first adjustment foot towards the direction approaching the bottom wall by the preset distance, such that the distance between the first free end and the bottom wall is decreased, or controlling the driving module to drive the second adjustment foot towards the direction away from the bottom wall by the preset distance, such that the distance between the second free end and the bottom wall is increased;
in response to determining that the second angle is less than a lower limit value of the second preset angle range, controlling the driving module to drive the first adjustment foot towards the direction away from the bottom wall by the preset distance, such that the distance between the first free end and the bottom wall is increased, or controlling the driving module to drive the second adjustment foot towards the direction approaching the bottom wall by the preset distance, such that the distance between the second free end and the bottom wall is decreased.

19. The adjusting method for the projection device as claimed in claim 18, wherein the second preset angle range is −y degrees to ty degrees, y is greater than or equal to 0 and less than or equal to 5.

20. The adjusting method for the projection device as claimed in claim 18, further comprising:
in response to determining that the second angle is less than the lower limit value of the second preset angle range, and the distance between the first free end of the first adjustment foot and the bottom wall reaches the maximum distance, controlling the driving module to drive the second adjustment foot towards the direction approaching the bottom wall by the preset distance, such that the distance between the second free end and the bottom wall is decreased;
in response to determining that the second angle is less than the lower limit value of the second preset angle range, the distance between the first free end of the first adjustment foot and the bottom wall reaches the maximum distance, and the distance between the second free end of the second adjustment foot and the bottom wall reaches the minimum distance, generating a second warning message;
in response to determining that the second angle is greater than the upper limit value of the second preset angle range, and the distance between the second free end of the second adjustment foot and the bottom wall reaches the maximum distance, controlling the driving module to drive the first adjustment foot towards the direction approaching the bottom wall by the preset distance, such that the distance between the first free end and the bottom wall is decreased;
in response to determining that the second angle is greater than the upper limit value of the second preset angle range, the distance between the first free end of the first adjustment foot and the bottom wall reaches the minimum distance, and the distance between the second free end of the second adjustment foot and the bottom wall reaches the maximum distance, generating the second warning message.
